(19) United States
(12) Patent Application Publication
(10) Pub. No.: US 2006/0061002 A1
(43) Pub. Date: Mar. 23, 2006

(54) Method for shaping wood-like plate by adhering foaming material and device for forming the same

(76) Inventors: Wen-Chang Huang, Chang Hua (TW); Sung-Bo Cheng, Chang Hua (TW)

Correspondence Address: Wen-Chang Huang, 235 Chung-Ho, Box 8-24, Taipei, TW

(21) Appl. No.: 11/237,521

(22) Filed: Sep. 29, 2005

Related U.S. Application Data
(63) Continuation-in-part of application No. 10/199,813, filed on Jul. 22, 2002, now abandoned.

(51) Int. Cl. B29C 44/12

(52) U.S. Cl. 264/46.6; 425/4 R

(57) ABSTRACT

A method for making a wood-like plate by using a mold structure comprises the steps of pushing a wood texture layer into the mold opening of the slit to enclosing the material feeding mold seat; guiding foaming material into the feeding opening of the material feeding mold seat; and forwarding the wood texture layer to encloses the shaped foam plate tightly adhered on the wood texture layer. By the expanding force of the foaming material, the wood texture layer will resist against the inner surface of the slit in an inner section of the material receiving mold seat since the length of the material feeding mold seat is shorter than the material receiving mold seat. The material is foamed as a wood-like plate along the shaping channel and then enclosed by the wood texture layer as a wood like plate. A device for processing the method is also enclosed.

The present invention is a continuation in part of U.S. patent Ser. No. 10/199,813 assigned to and invented by the inventor of the present invention. Thus the contents of the U.S. patent Ser. No. 10/199,813 is incorporated into the present invention as a part of the specification of the present invention.

### FIELD OF THE INVENTION

The present invention relates to wood-like plates, and particularly to a method nad a device for shaping a wood-like plate by adhering foaming material.

### BACKGROUND OF THE INVENTION

For the reason of environmental protection, wood becomes an important resource and is not suitable to various applications. Thereby, wood-like plates are developed, such as wood-like plate made of plastics which is shaped by foaming. Furthermore, the wood has the following disadvantages. The wood is more and more expensive due to resource protection. The finish work is too complex so that the cost is high. Textures and colors of wood plates are not uniform from one to one. The wood is easily deformed due to heat or water.

Although wood-like plate has textures similar to woods, it cannot completely like the wood. To increase the hardness of this wood-like plate, in general foaming process is applied to the wood-like plate and then a wood texture layer is adhere to the plate.

Referring to FIGS. 1, 1A and 1B, in the prior art, a foamed plate 2 is outputted from the material output 31 of a shaping mold 3 and then a wood texture layer is adhered to the plate by a roller G to move the surface of the plate.

However, this prior art way is complicated and inconvenient. Thereby, the cost is high. Moreover, the texture layer cannot be uniformly adhered to the wood-like plate and bubbles are generated in the texture layer. Thereby, the surface of the plate 2 is uneven. After it is used for a long time, or is placed for a time period, the texture layer P at the corners will be peeled off. Moreover, the corners must be enclosed. This further increases the complexity in packaging.

Moreover, the rolling operation is more suitable for the flat plate surface, but is unsuitable for some decorating strips in the periphery of the plate. Thereby, the manufacturer must add some decorating strips to match the wood-like plate.

### SUMMARY OF THE INVENTION

Accordingly, the primary object of the present invention is to provide a method for making a wood-like plate by using a mold structure. The method comprises the steps of pushing a wood texture layer into the mold opening of the slit to enclose the material feeding mold seat; guiding foaming material into the feeding opening of the material feeding mold seat; and forwarding the wood texture layer to encloses the shaped foam plate tightly adhered on the wood texture layer; by the expanding force of the foaming material. The wood texture layer will resist against the inner surface of the slit in an inner section of the material receiving mold seat since the length of the material feeding mold seat is shorter than the material receiving mold seat. The material is foamed as a wood-like plate along the shaping channel and then enclosed by the wood texture layer as a wood like plate. A device for processing the method is also enclosed.

The various objects and advantages of the present invention will be more readily understood from the following detailed description when read in conjunction with the appended drawing.

### BRIEF DESCRIPTION OF THE DRAWINGS

FIG. 1 is a schematic view showing the shaping and finishing work of a prior art wood.

FIG. 1A is a schematic cross sectional view of a prior art wood adhering work.

FIG. 1B is another schematic cross sectional view of a prior art wood adhering work.

FIG. 2 is a schematic perspective view showing the shape of a wood-like plate of the present invention.

FIG. 2A is a schematic perspective view of the material feeding mold seat of the present invention.

FIG. 3 is a schematic perspective view showing the shaping and adhering process of the wood-like plate of the present invention.

FIG. 4A is a cross sectional view of the shaping mold of the present invention.

FIG. 4AA is used to assist the description of FIG. 4A.

FIG. 4B is a cross sectional view of the shaping mold of the present invention.

FIG. 4BB is an enlarge view for assisting the description of FIG. 4B.

FIG. 4C is another cross sectional view of the shaping mold of the present invention.

FIG. 4CC is an enlarge view for assisting the description of FIG. 4B.

FIG. 4D is a further cross sectional view of the shaping mold of the present invention.

FIG. 4DD is an enlarge view for assisting the description of FIG. 4B.

FIG. 5 is a schematic perspective view showing the shaping and adhering process of the wood-like plate in the second embodiment of the present invention.

FIG. 6 is a perspective view showing a finished product of the second embodiment of the present invention.

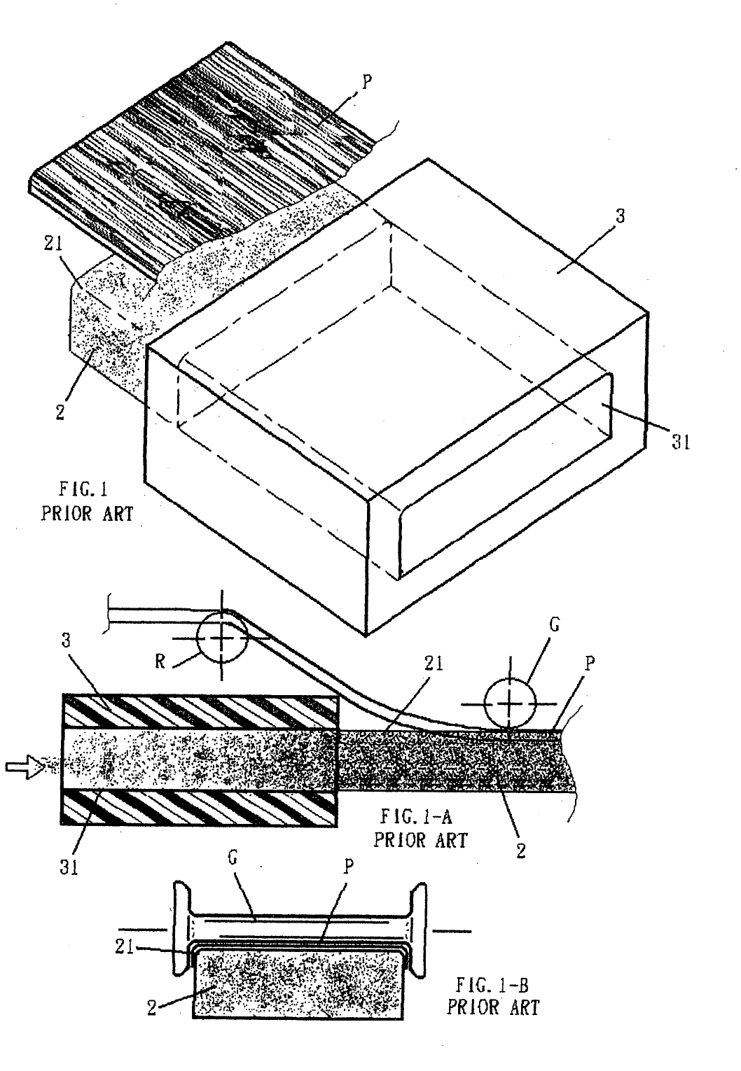

### DETAILED DESCRIPTION OF THE PREFERRED EMBODIMENTS

To be further understood the present invention with the appended drawings.

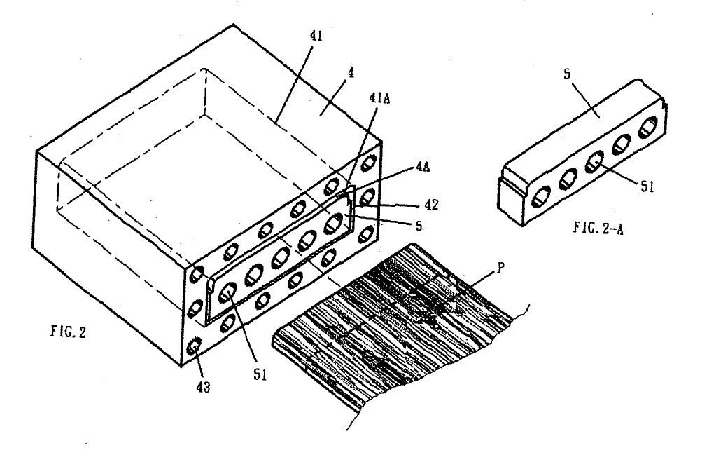

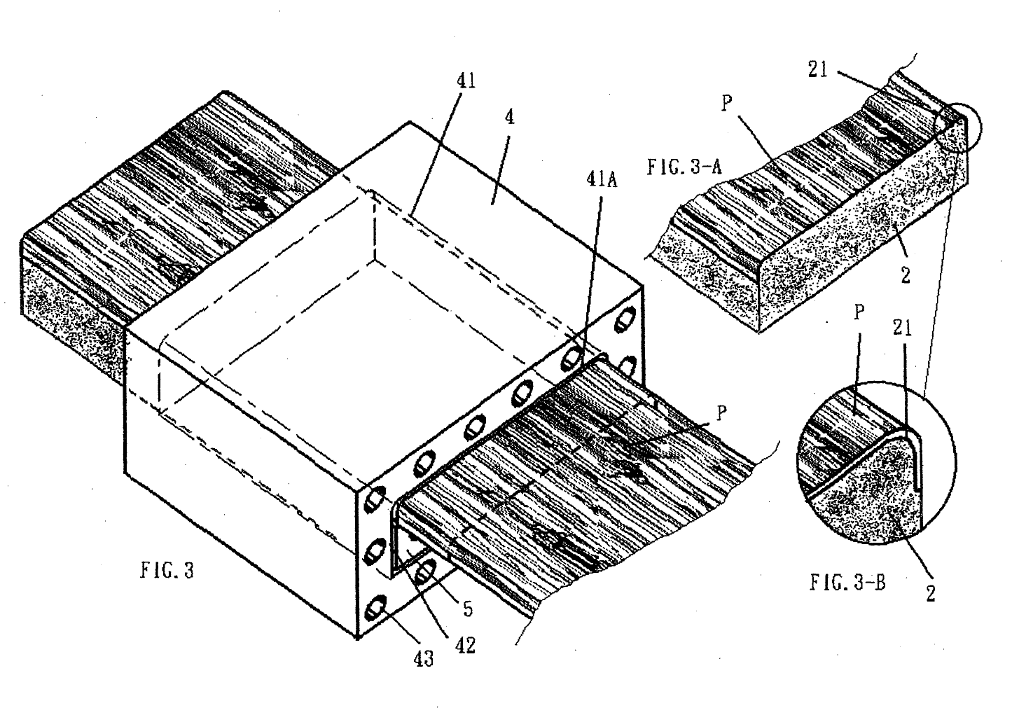

Referring to FIGS. 2, 2A, 3 and 3A, 3B, the structure of the present invention is illustrated. In the mold structure of the present invention, the structure of the present invention has the following elements.

A material receiving mold seat 4 is included.

A shaping channel 41 is formed in an inner side of the material receiving mold seat 4. The shaping channel 41 has a receiving opening 42.

A material feeding mold seat 5 is located in the receiving opening 42 on the material receiving mold seat 4.

A middle section of the material feeding mold seat 5 has a plurality of material feeding openings 51 for guiding foaming material 2A.

A slit 41A is formed between the material feeding mold seat 5 and the material receiving mold seat 4. The length of the material feeding mold seat 5 is shorter than the shaping channel 41.

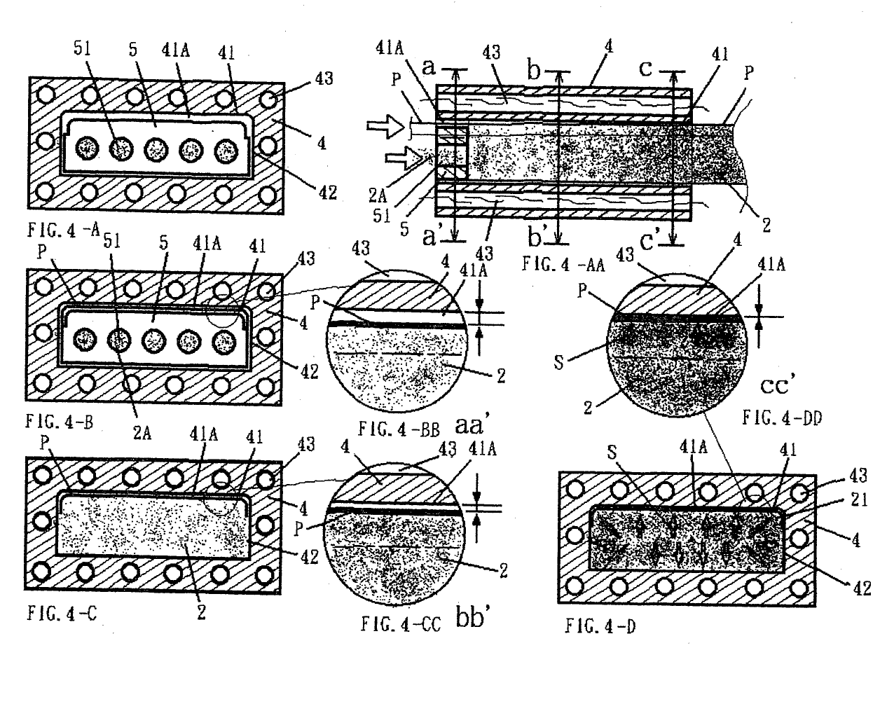

Referring to FIGS. 4A, 4AA, 4B and 4BB. By above-mentioned structure, the process of the present invention will be described herein.

A wood texture layer P is pushed into the mold opening 42 of the slit 41A to enclosing the material feeding mold seat 5. Foaming material 2A is guided into the feeding opening 51 of the material feeding mold seat 5. The feeding opening 51 penetrates through the material feeding mold seat 5. By the foaming effect, the melting foaming material 2A is protruded out from the openings 51 of the material feeding mold seat 5 at another side, then forms a shape like the channel and is tightly adhered on the wood texture layer P. Moreover, by the expanding force S of the material 2A (referring to the arrows in FIGS. 4A and 4DD), the wood texture layer P will resist against the inner surface of the slit 4A in the inner section of the material receiving mold seat 4 (FIGS. 4BB, 4CC and 4DD show the foaming, shaping and adhering processes) since the length of the material feeding mold seat 5 is shorter than the material receiving mold seat 4. The material is foamed as a wood-like plate 2 along the shaping channel 41 so as to complete the operation of adhering and flattening the wood texture layer P.

To have a preferred wood-like plate 2, a plurality of cooling channels 43 (gas cooling or water cooling) can be longitudinally arranged in the material receiving mold seat 4. Thereby, the foaming process is slower near the outer side of the shaping channel 41 and is quicker near a center portion of the shaping channel 41. Thereby, the foaming rate is high in the inner section so as to have a preferred expansion effect from the inner side to the outer side. Thereby, the it is shaped along the type of the inner wall of the shaping channel (referring to FIGS. 2, 3 and 4).

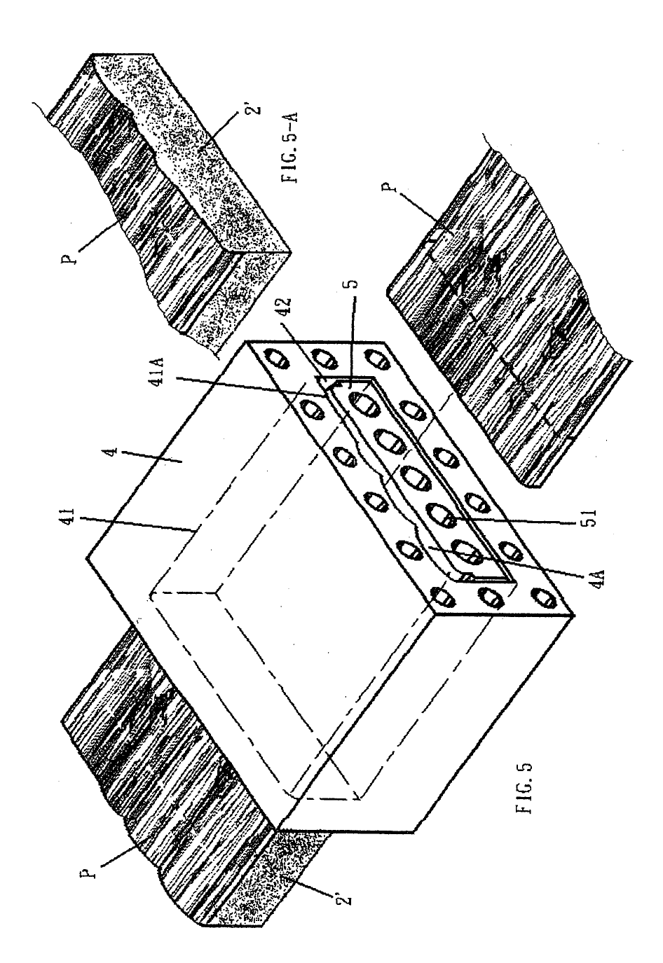

With reference to FIGS. 4 and 5A, in the present invention, the material 2A expands outwards, so that the wood-like plate 2 is shaped along the inner wall of the shaping channel to complete the adhering operation of the wood texture layer P. By designing the top surface 41A of the shaping channel 41, the wood texture layer P can be pushed upwards to have a shape same as the top surface 41A. Thereby, the wood-like plate can be formed with decorating strips (or engraved strips). The wood texture layer P is well matched to the wood-like plate 2 so as to be used widely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for making a wood-like plate by using a mold structure, the structure comprising:
a material receiving mold seat;
a shaping channel formed in an inner side of the material receiving mold seat; the shaping channel having a receiving opening;
a material feeding mold seat located in the receiving opening of the material receiving mold seat; the material feeding mold seat having a plurality of material feeding openings penetrating through the material feeding mold seat for guiding foaming material;
a slit formed between the material feeding mold seat and material receiving mold seat; the length of the material feeding mold seat being shorter than the shaping channel and a front end of the feeding mold seat being flushed with a front end of the material receiving mold seat;
the method comprising the steps of:
pushing a wood texture layer into the mold opening of the slit to enclosing the material feeding mold seat;
guiding foaming material into the feeding opening of the material feeding mold seat; the feeding opening penetrating through the material feeding mold seat; by the foaming effect, the melting foaming material being protruded out from the openings of the material feeding mold seat at another side, then forming a shape like the channel; and
forwarding the wood texture layer so as to encloses the shaped foam plate tightly adhered on the wood texture layer; by the expanding force of the foaming material, the wood texture layer will resist against the inner surface of the slit in an inner section of the material receiving mold seat since the length of the material feeding mold seat is shorter than the material receiving mold seat; the material is foamed along the shaping channel and then enclosed by the wood texture layer as a wood like plate.

2. The method for making a wood-like plate as claimed in claim 1, wherein a plurality of cooling channels are longitudinally arranged in the material receiving mold seat; thereby, the foaming process is slow near an outer side of the shaping channel and is quick near a center portion of the shaping channel.

3. The method for making a wood-like plate as claimed in claim 1, wherein the shaping channel has a wave-like shape so that the wood-like plate has a corresponding texture.

4. A device for making a wood-like plate by using a mold structure comprising:
a material receiving mold seat;
a shaping channel formed in an inner side of the material receiving mold seat; the shaping channel having a receiving opening;
a material feeding mold seat located in the receiving opening of the material receiving mold seat; the material feeding mold seat having a plurality of material feeding openings penetrating through the material feeding mold seat for guiding foaming material; and
a slit formed between the material feeding mold seat and material receiving mold seat; the length of the material feeding mold seat being shorter than the shaping channel and a front end of the feeding mold seat being flushed with a front end of the material receiving mold seat.

5. The device for making a wood-like plate as claimed in claim 4, wherein a plurality of cooling channels are longitudinally arranged in the material receiving mold seat; thereby, the foaming process is slow near an outer side of the shaping channel and is quick near a center portion of the shaping channel.

6. The method for making a wood-like plate as claimed in claim 4, wherein the shaping channel has a wave-like shape so that the wood-like plate has a corresponding texture.
